(19) United States
(12) Patent Application Publication
(10) Pub. No.: US 2006/0209075 A1
(43) Pub. Date: Sep. 21, 2006

(54) METHOD FOR GENERATING A DOT-BASED IMAGE OF A CHARACTER BY SCALING STROKES OF THE CHARACTER

(76) Inventors: Fu-Sheng Wu, Tao-Yuan Hsien (TW); Yi-Hui Huang, Taipei Hsien (TW); Hsieh-Chih Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/160,772

(22) Filed: Jul. 8, 2005

(30) Foreign Application Priority Data
Mar. 17, 2005 (TW) 094108178

(51) Int. Cl. G06T 11/00

(52) U.S. Cl. 345/472

(57) ABSTRACT

A method generates a dot-based image of a character (such as a Chinese character) by establishing a monochrome or gray-scale stroke data set, selecting a plurality of strokes from the stroke data set, scaling the selected strokes, and combining and adjusting the strokes to form the dot-based image of the character.

### BACKGROUND OF INVENTION

1. Field of the Invention

The present invention relates to a method for generating a dot-based image of a character, and more specifically, to a method for generating a dot-based image of a character by scaling strokes of the character.

2. Description of the Prior Art

Electronic devices have developed over the years, and handheld information appliances (IA), such as mobile phones, set-top boxes, personal digital assistants (PDAs), and mp3 media players, are more popular than ever. Almost every IA device has a display screen to show related information for user operation. These small-sized IA devices commonly show smaller dot characters with their display, unlike many desktop LCD displays, which have the ability of displaying characters of all sizes.

However, the prior art display method of a dot-based image of a character records every single fixed-size character one by one, by which each dot-based image of the character takes up a certain amount of memory. An IA device using a Chinese character set requires even more memory. There is another font displaying technique named “vector font technology” which uses mathematical operations, which can solve the large memory occupation problem of the dot character displaying technique. The vector font is capable of being enlarged or reduced freely by mathematical operation. However, operating the vector font takes even more processor resources, which may cause a serious delay since common handheld IA devices are equipped with slower processors. Also, the display quality of a vector font is even worse than a dot character when the displayed font is small-sized, which is major to IA devices.

### SUMMARY OF INVENTION

Therefore, the primary objective of the present invention is to provide a method for generating a dot-based image of a character by scaling strokes of the character to solve the above-mentioned problem.

The present invention provides a method for generating a dot-based image of a character by scaling strokes of the character. The method comprises the following steps: (a) establishing a dot stroke data set having a plurality of dot strokes, (b) selecting strokes from the stroke data set, (c) scaling the strokes selected in step (b), and (d) combining the strokes to form the dot-based image of the character.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a flow chart of the present invention's dot-based character image generating method.

FIG. 2 illustrates a monochrome dot-based image of a transverse stroke.

FIG. 3 illustrates a shrinking gray-scale dot-based image of the monochrome dot-based image of the transverse stroke.

FIG. 4 illustrates a dot stroke drawn in a matrix frame according to a start position (Dx, Dy) in the matrix frame.

FIG. 5 to FIG. 7 are three exemplary embodiments of the present invention that adjust a character.

### DETAILED DESCRIPTION

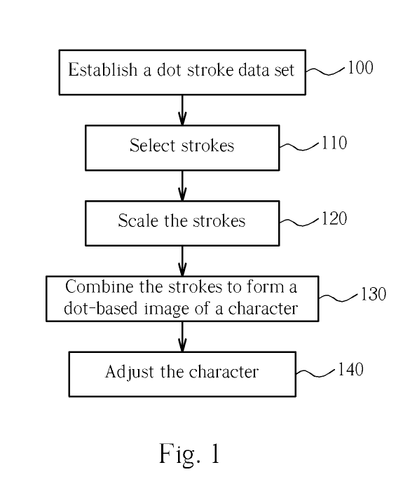

Please refer to FIG. 1, which is a flow chart of the present invention's dot-based character image generating method. The method comprises the following steps:

Step 100: Establish a dot stroke data set by manual analysis or by analysis of a vector font data set;

Step 110: Select strokes from the stroke data set according to a character about to be formed;

Step 120: Scale the strokes selected in Step 110 according to the size of the character about to be formed;

Step 130: Combine the strokes to form the character;

Step 140: Adjust the strokes of the character combined in Step 130.

The present invention's dot-based character image generating method, by scaling the strokes of the character, establishes in advance a monochrome dot stroke data set or a gray-scale dot stroke data set in a memory. The dot stroke data comprises a plurality of dot strokes for forming a Chinese character. As Step 100 describes, the plurality of dot strokes in the dot stroke data set is established based on users' common analysis or through analysis of a prior art's vector font data set. To make the follow-up scaling simple, the scaling is done in detail with dot strokes; therefore, the present invention establishes the dot stroke data set in step 100 that will include as many dot strokes as possible. For a transverse stroke of a Chinese character, for example, the dot stroke data set includes various lengths of transverse strokes.

In addition, it is more intuitional and easier for a larger character to be reduced to a smaller character when scaling it, while one must add lots of stroke information when enlarging a smaller character to a larger one since the smaller character has less stroke information. Although the enlargement can be performed with interpolation, it is still a much more complicated task. In step 100, the present invention's dot-based character image generating method establishes a dot stroke data set having a plurality of dot strokes of predetermined size that are capable of including strokes of the largest size of target characters to be formed. That can minimize the degradation of quality when scaling strokes.

When a plurality of dot strokes are selected for analysis, any single stroke of the plurality of selected dot strokes can be pre-adjusted to a dot stroke with higher quality if needed. It is sufficient to establish one dot stroke data set in the present invention, but it can also establish a second set or more dot stroke data sets for a particular requirement for quality. The present invention provides a possibility to establish a dot stroke data set with the most commonly used font size of an IA device to which it will be applied. For example, if an IA device mostly uses characters of the size of 16×16 dots, the present invention is capable of establishing a second dot stroke data set having a plurality of strokes with the size of 16×16 dots. It can directly combine the strokes to form a character without scaling the strokes, which further reduces the problem of scaling.

Subsequent strokes are selected from the dot stroke data set according to a character about to be formed as described in Step 110. Each dot stroke comprises a stroke code and a dot-based image, wherein the dot-based image is the actual image of the dot stroke. Each dot character includes stroke codes of all the dot strokes that form the dot character, a starting point of within a matrix frame of each dot stroke, and the dot character code of it own. In Step 110, the present invention selects strokes according to the dot stroke codes included in the dot character.

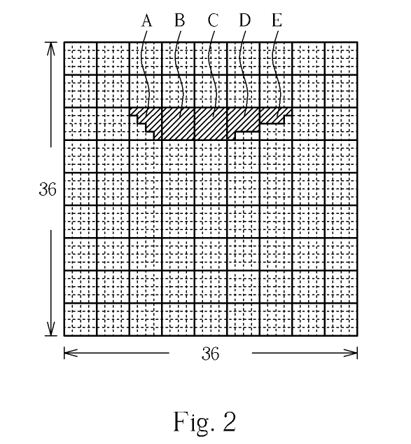

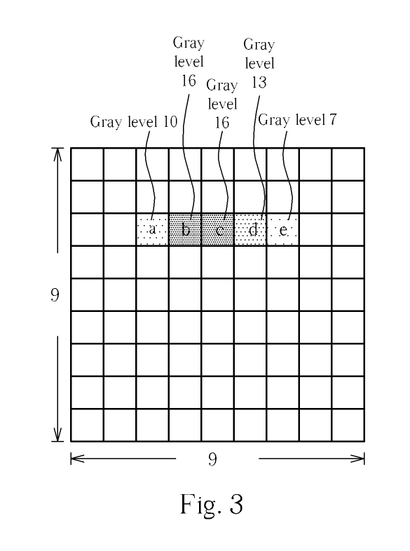

Please refer to FIG. 2 and FIG. 3. In Step 120, the present invention scales the dot strokes selected in Step 110 according to the size of the dot character about to be formed. Assume that the dot stroke data set established in Step 100 is a monochrome dot stroke data set and take a transverse stroke for example, as FIG. 2 shows. If we want to reduce an original dot stroke of 36×36 dots to a target dot stroke of 9×9 dots as in FIG. 3, we can first slice the original dot stroke in FIG. 2 into five information segments of 4×4 dots, wherein segment A comprises 10 effective dots, segments B, and C comprise 16 effective dots each (wherein ‘16 effective dots’ stands for ‘full effectiveness of dot’ in this case), segment D comprises 13 effective dots, and segment E comprises 7 effective dots. These five information segments will be outputted as five dots in the target dot stroke of 9×9 dots. Since the original dot stroke includes more dot information than the target dot stroke, the five dots of the target dot stroke can be gray-scale, in which the gray level of each dot in the target dot stroke is decided by the number of effective dots of each information segment of the original dot stroke. As mentioned above, the original dot stroke in FIG. 2 is reduced to the target dot stroke in FIG. 3 in a gray-scale manner. The present invention is also capable of reducing an original dot stroke to a monochrome target dot stroke, that is, it reduces the stroke monochromatically. There will be no gray level difference between the five dots of the target dot stroke, when done in a monochrome reducing manner. These five dots can be all black or have different dot content according to manual adjustment. For instance, a user can set a rule that if the effective dots of any information segment are more than half the full effectiveness of the dot, then the corresponding dot in the target dot stroke is set to be black. If such a rule is applied on the exemplary embodiment, then we will have dots ‘a’, ‘b’, ‘c’, and ‘d’ as black dots in the target dot stroke. On the other hand, if the effective dots of any information segment are less than half the full effectiveness of dot, then the corresponding dot in the target dot stroke is set to be white; we will get a white dot ‘e’ in the target dot stroke in this exemplary embodiment, for example.

If a gray-scale dot stroke data set is established in Step 100, then the original dot stroke includes even more information than a stroke in the monochrome dot stroke data set. When the gray-scale dot stroke is reduced to a target dot stroke, each dot of the target dot stroke can have larger gray-scale range to express the detail of the target dot stroke. Monochrome target dot stroke output is also available, of course. In another exemplary embodiment of the present invention, segment A of the original dot stroke in FIG. 2 includes 10 effective dots, wherein each effective dot has a gray level, and the sum of the gray level of these 10 effective dots in segment A is calculated. If the sum turns out to be 375 (wherein we may have 1000 as the sum of the full effectiveness of the dot), then dot ‘a’ of the target dot stroke corresponding to segment A will be white, if strokes are reducing monochromatically. If strokes are reduced in a gray-scale manner, the gray level of dot ‘a’ corresponding to segment A will be ‘full effectiveness of dot’ multiplied by 375/1000, that is, 16*(375/1000)=6.

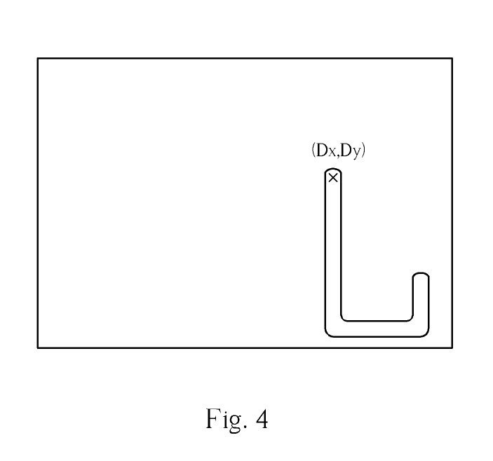

Please refer to FIG. 4, where the present invention combines the scaled strokes to form a dot character in Step 130. As mentioned before, each dot character includes the information of stroke codes of all the dot strokes that form the dot character, a starting point from within a matrix frame of each dot stroke, and a dot character code of its own. During the process of combining the strokes to form the character, each dot stroke is drawn in a matrix frame according to its starting point (Dx, Dy), as FIG. 4 shows. Two ways of combination are introduced. While outputting a monochrome dot character, one must simply draw each dot stroke in the matrix frame and need not consider the overlap of strokes. If the output dot character is gray-scale, than the parts of each stroke that do not overlap with other strokes are drawn in the matrix frame according to the gray-scale of each dot of the stroke. Considering the parts that do have overlap with other strokes, each overlapping dot is drawn as the dot with the maximum relative gray level.

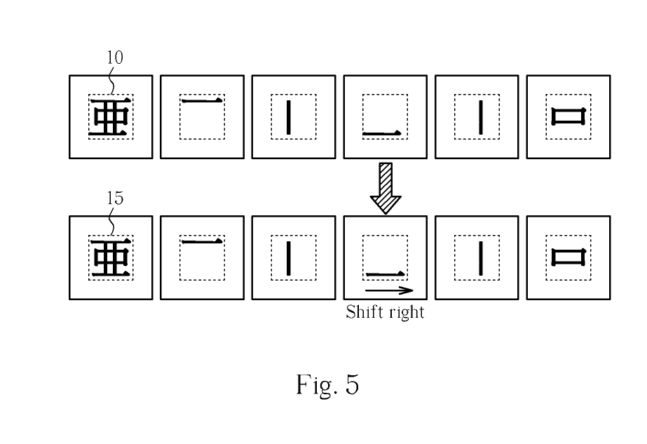

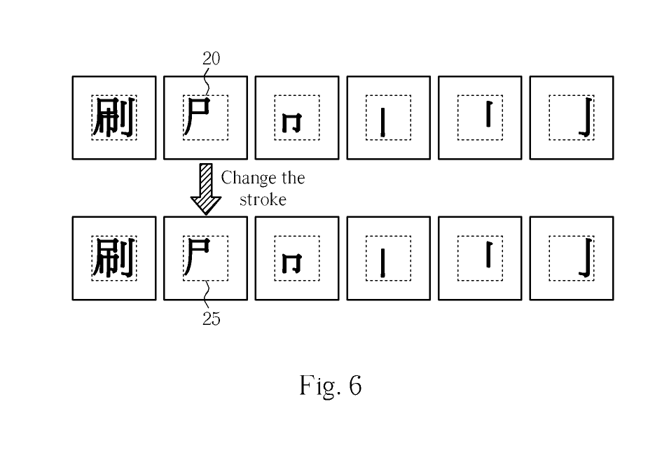

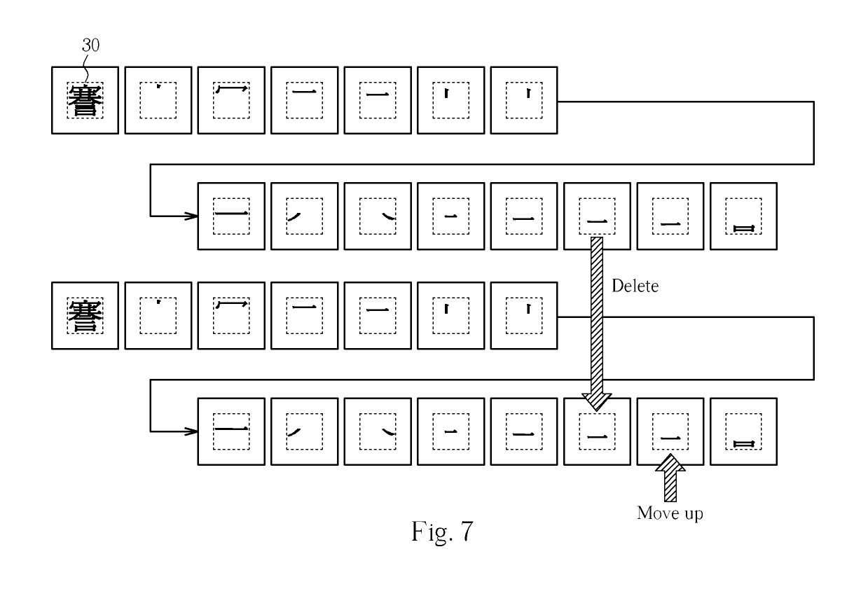

Finally please refer to FIG. 5 to FIG. 7. The formed character outputted in Step 130 might not always appear in proportion. Adjusting the strokes of the formed dot character as in Step 140 to increase readability can solve problems, like one stroke lying on the top of another, inappropriate placement of one stroke, or selection of a disproportionate stroke. FIG. 5 to FIG. 7 depict three exemplary embodiments of the present invention's adjustment of an outputted dot character. In FIG. 5, the bottom transverse stroke of a Chinese character 10 is shifted right to form a more balanced Chinese character 15. In FIG. 6, the strokes of the outputted dot character will seem to be more balanced when changing stroke 20 to a more suitable stroke 25. FIG. 7 shows that there will be overlapping with two transverse strokes of the lower half part of the Chinese character 30 when reducing the size of the character 30. By adjusting the stroke as in Step 140, one transverse stroke is deleted, and some transverse strokes are moved up to output a more balanced stroke alignment.

In summary, the present invention establishes a monochrome or gray-scale dot stroke data set and scales the dot strokes to form a dot character of an arbitrary size within a displaying range. It has the advantages of low memory usage, high processing speed, and high output quality. Therefore the present invention can effectively solve many problems caused by the prior art's dot character displaying technology applied on popular IA devices.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for generating a dot-based image of a character by scaling strokes of the character comprising:
(a) establishing a dot stroke data set having a plurality of dot strokes;
(b) selecting strokes from the stroke data set;
(c) scaling the strokes selected in step (b); and
(d) combining the strokes to form the dot-based image of the character.

2. The method of claim 1 wherein the dot stroke data set is for forming a Chinese character.

3. The method of claim 1 wherein step (a) comprises establishing the dot stroke data set having a plurality of dot strokes of predetermined size.

4. The method of claim 1 wherein step (a) comprises establishing the dot stroke data set by analysis of a vector font data set.

5. The method of claim 1 wherein step (a) comprises establishing a monochrome dot stroke data set.

6. The method of claim 1 wherein step (c) comprises scaling the strokes selected in step (b) monochromatically.

7. The method of claim 1 wherein step (a) comprises establishing a gray-scale dot stroke data set.

8. The method of claim 1 wherein step (c) comprises scaling the strokes selected in step (b) in gray-scale.

9. The method of claim 8 wherein step (d) comprises taking a maximum gray level of a dot as the representative gray level of the dot.

10. The method of claim 1 wherein step (b) comprises selecting the strokes from the stroke data set according to a plurality of dot stroke codes included in the dot-based image of the character.

11. The method of claim 1 wherein step (d) comprises combining the strokes to form the dot-based image of the character according to a plurality of dot stroke codes and a plurality of dot stroke starting points included in the dot-based image of the character.

12. The method of claim 1 further comprising step (e) adjusting the dot-based image of the character formed in step (d).

13. The method of claim 12 wherein step (e) comprises adjusting the dot-based image of the character by shifting a stroke, changing a stroke, or deleting a stroke.
